(19) United States
(12) Patent Application Publication
(10) Pub. No.: US 2025/0385450 A1
(43) Pub. Date: Dec. 18, 2025

(54) ELECTRICAL CONNECTOR

(71) Applicant: Molex, LLC, Lisle, IL (US)

(72) Inventors: Lin Tong, Dongguan (CN); Xing-Qiang He, Dongguan (CN); Wen-Chieh Liang, New Taipei (TW)

(21) Appl. No.: 19/209,858

(22) Filed: May 16, 2025

(30) Foreign Application Priority Data
Jun. 14, 2024 (CN) 202410772603.7

(51) Int. Cl. H01R 12/71; H01R 12/70; H01R 12/73; H01R 13/50; H01R 13/6471; H01R 13/6596

(52) U.S. Cl. CPC H01R 12/716; H01R 12/707; H01R 12/73; H01R 13/50; H01R 13/6471; H01R 13/6596

(57) ABSTRACT

An electrical connector is provided and includes: a first insulative housing, a front end of the first insulative housing is provided with a first mating cavity; a plurality of first conductive terminals which are arranged in the first mating cavity; a plurality of wires which are correspondingly connected to rear ends of the plurality of first conductive terminals; a protect housing which is provided to a rear end of the first insulative housing; a ribbon sealing member which wraps on an outer peripheral of the plurality of wires to seal gaps between respective adjacent wires; wherein, one end of the ribbon sealing member is sealed in the protect housing, the other end of the ribbon sealing member extends outwardly to be exposed out from the protect housing. The ribbon sealing member seals the gaps between the respective adjacent wires, which in turn can prevents a molten plastic material from seeping through the gaps between the respective adjacent wires; because a molding die presses against the ribbon sealing member, which substantially is flat, in an injection molding process, the molding die does not need to form recessed grooves which each correspond to an outer peripheral of each wire, so processing of the molding die will be easier and cost also is lower.

### TECHNICAL FIELD

The present disclosure relates to technical field of connectors, and particularly relates to an electrical connector.

### BACKGROUND

Chinese patent document CN116565595A discloses an electrical connector including: a first insulative housing, a front end of the first insulative housing is provided with a first mating cavity and a receiving cavity; a plurality of first conductive terminals respectively provided to an upper side and a lower side of the first mating cavity, each first conductive terminal includes a first contact portion which extends forwardly and a wire connecting portion which extends rearwardly; a plurality of wires respectively connected to the wire connecting portions of the plurality of first conductive terminals; a second insulative housing which inserts into the receiving cavity; a plurality of second conductive terminals fixed on the second insulative housing, the second conductive terminal includes a second contact portion which extends forwardly and a connecting leg which extends rearwardly, the connecting leg of the second conductive terminal is used to establish an electrical connection with a circuit board. The electrical connector is further provided with a protect housing, the connector protect housing may be injection molded after the plurality of wires and the plurality of first conductive terminals are soldered, which ensures reliability of the electrical connections between the plurality of wires and the plurality of first conductive terminals, prevents an external pulling force from being transferred to the first conductive terminal via the wire, so as to promote stability of signals to be transmitted.

However, in the technical solution, the protect housing is formed by a molding die presses against the plurality of wires and then a molten plastic material is injected into the molding die for injection molding, because the molding die needs to be formed with recessed grooves which each correspond to an outer peripheral of each wire, processing of the molding die is more difficult and cost of the molding die is higher. In addition, when a wiring manner defined by a client changes (for example, when the number of the wires or wire outgoing positions of the wires needs to be adjusted), it often needs to develop a new molding die to accommodate the new wiring manner, cost of the molding die is high and manufacturing time of the molding die is long.

### SUMMARY

A technical problem to be solved by the present disclosure is to provide an electrical connector in which a requirement on a molding die is lower and the molding die also does not need to be changed when a wiring manner changes in order to overcome deficiency in the prior art.

In order to solve the above technical problem, the present disclosure provides an electrical connector comprising: a first insulative housing, a front end of the first insulative housing is provided with a first mating cavity; a plurality of first conductive terminals which are arranged in the first mating cavity; a plurality of wires which are correspondingly connected to rear ends of the plurality of first conductive terminals; a protect housing which is provided to a rear end of the first insulative housing; a ribbon sealing member which wraps on an outer peripheral of the plurality of wires to seal gaps between respective adjacent wires; wherein the protect housing is formed by injection molding and partially covers an outer peripheral of the ribbon sealing member, one portion of the ribbon sealing member is embedded in the protect housing, the other portion of the ribbon sealing member extends outwardly to be exposed out from the protect housing.

In some embodiments, the ribbon sealing member has adhesive, and is adhered with the plurality of wires together.

In some embodiments, the ribbon sealing member is an insulative adhesive tape, the protect housing is integrally molded on the rear end of the first insulative housing so that the protect housing covers a portion of the ribbon sealing member close to the plurality of first conductive terminals therein.

In some embodiments, the plurality of first conductive terminals are arranged into an upper row and a lower row, the electrical connector further comprises at least one first shielding plate which is provided between the upper row of first conductive terminals and the lower row of first conductive terminals, the first shielding plate is in form of wave-shape and extends along an arrangement direction of the first conductive terminals, the first shielding plate comprises multiple peak portions and multiple valley portions which are alternately arranged, the valley portion is provided thereon with a through hole, ground terminals of the first conductive terminals are welded to the peak portions.

In some embodiments, the plurality of first conductive terminals comprises multiple groups of differential signal pair terminals, each group of differential signal pair terminal comprises two signal terminals which are provided in pair and the two ground terminals which are respectively positioned to two sides of the two signal terminals, the two signal terminals does not contact the first shielding plate, and the two signal terminals and the valley portion form a spacing therebetween.

In some embodiments, each first conductive terminal comprises an elastic mating portion, a soldering portion which is connected with the wire and a fixing portion which is connected between the elastic mating portion and the soldering portion, in the same group of differential signal pair terminal, the two soldering portions of the two ground terminals extend closes to each other relative to the two elastic mating portions of the two ground terminals.

In some embodiments, the soldering portion of the ground terminal comprises a soldering portion front section which is connected with the fixing portion and a soldering portion rear section which is bent from the soldering portion front section and is used to be connected with the wire, in the same group of differential signal pair terminal, a pitch between the two soldering portion rear sections of the two ground terminals is smaller than a pitch between the two soldering portion front sections of the two ground terminals.

In some embodiments, a thickness of the soldering portion of the first conductive terminal is smaller than a thickness of the other portion of the first conductive terminal.

In some embodiments, outer peripherals of connected positions between the soldering portions of the first conductive terminals and the wires are covered with a protecting adhesive layer.

In some embodiments, the first insulative housing is provided with a receiving cavity at a side of the first mating cavity, the electrical connector further comprises a second insulative housing and a plurality of second conductive terminals, the second insulative housing is inserted into the receiving cavity, a front end of the second insulative housing is provided with a second mating cavity, the plurality of the second conductive terminals are arranged in the second mating cavity.

In comparison with the prior art, the present disclosure at least has following advantages: the electrical connector of the present disclosure includes a first insulative housing, a plurality of first conductive terminals, a plurality of wires, a protect housing and a ribbon sealing member. Wherein, the ribbon sealing member wraps an outer peripheral of the plurality of wires to seal gaps between the plurality of wires; one end of the ribbon sealing member is sealed in the protect housing, the other end of the ribbon sealing member extends outwardly to be exposed out from the protect housing. In the electrical connector, the ribbon sealing member wraps and covers the outer peripheral of the plurality of wires to seal the gaps between the plurality of wires, which can prevent a molten plastic material from seeping through the gaps between the plurality of wires when the protect housing is injection molded; because a molding die presses against the ribbon sealing member, which substantially is flat, in an injection molding process, the molding die does not need to form recessed grooves which each correspond to an outer peripheral of each wire, so processing of the molding die will be easier and cost also is lower. And when a wiring manner changes, because the ribbon sealing member has sealed the gaps between the plurality of wires, in the case that the change in the wiring manner is smaller, the original molding die may be continuously used to integrally injection mold the protect housing, in turn cost and time of changing the molding die required due to change of the molding die are saved.

### BRIEF DESCRIPTION OF THE DRAWINGS

FIG. 1 is a perspective view of a preferred embodiment of an electrical connector of the present disclosure.

FIG. 2 is a perspective view of FIG. 1 viewed from another angle.

FIG. 3 is a front view of FIG. 2.

FIG. 4 is a perspective exploded view of the electrical connector and a protect housing of the present disclosure.

FIG. 5 is a further exploded perspective view of the electrical connector of the present disclosure.

FIG. 6 is a more further exploded perspective view of the electrical connector of the present disclosure.

FIG. 7 is a perspective exploded view of FIG. 6 viewed from another angle.

FIG. 8 is a more further exploded perspective view of the electrical connector of the present disclosure.

FIG. 9 is a top view of first conductive terminals, a first shielding plate and a second shielding plate of the present disclosure.

FIG. 10 is a side view of FIG. 9.

FIG. 11 is a perspective view of the first conductive terminals, the first shielding plate and the second shielding plate of the present disclosure.

FIG. 12 is a partially enlarged view of a part of FIG. 11 indicated by A.

FIG. 13 is a front view of FIG. 11.

FIG. 14 is a partially enlarged view of a part of FIG. 13 indicated by B.

FIG. 15 is an exploded perspective view of the first conductive terminals, the first shielding plate and the second shielding plate of the electrical connector of the present disclosure.

FIG. 16 is a perspective view of a differential signal pair terminal of the present disclosure.

FIG. 17 is a perspective view of the first shielding plate of the present disclosure.

FIG. 18 is a perspective view of a preferred embodiment of an electrical connector assembly of the present disclosure.

FIG. 19 is a perspective view of FIG. 18 viewed from another angle.

### DETAILED DESCRIPTION

While the present disclosure may be susceptible to embodiments in different forms, there are shown in the figures, and will be described herein in detail, are only specific embodiments, with the understanding that the present disclosure is to be considered as an exemplification of the principles of the present disclosure, and is not intended to limit the present disclosure to that as illustrated.

Hence references to a feature are intended to describe a feature of an embodiment of the present disclosure, not to imply that every embodiment thereof must have the described feature. Furthermore, it should be noted that the description illustrates a number of features. While certain features have been combined together to illustrate potential system designs, those features may also be used in other combinations not expressly disclosed. Thus, the depicted combinations are not intended to be limiting, unless otherwise noted.

In the embodiments illustrated in the figures, representations of directions such as up, down, left, right, front and rear, used for explaining the structure and movement of the various parts of the present disclosure, are not absolute, but relative. These representations are appropriate when the parts are in the position shown in the figures. If the description of the position of the parts changes, however, these representations are to be changed accordingly.

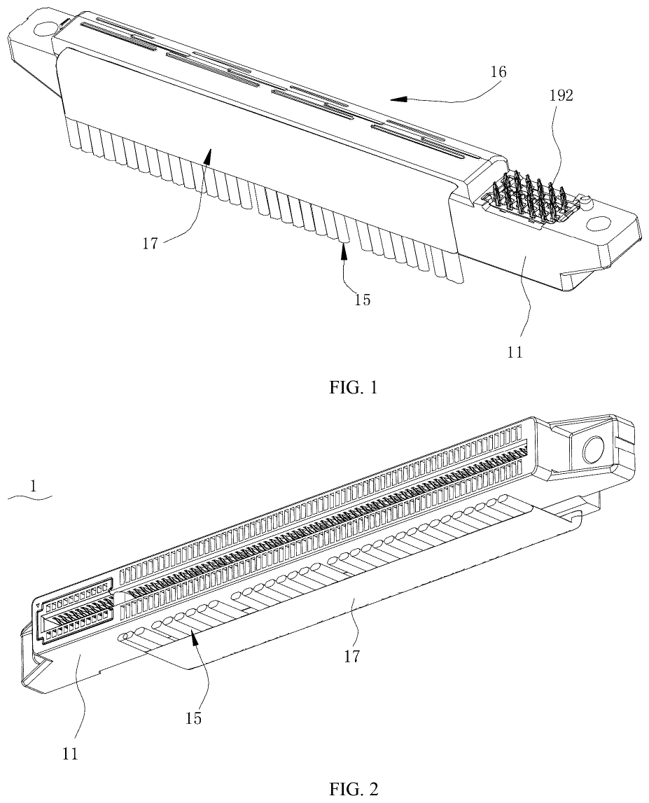

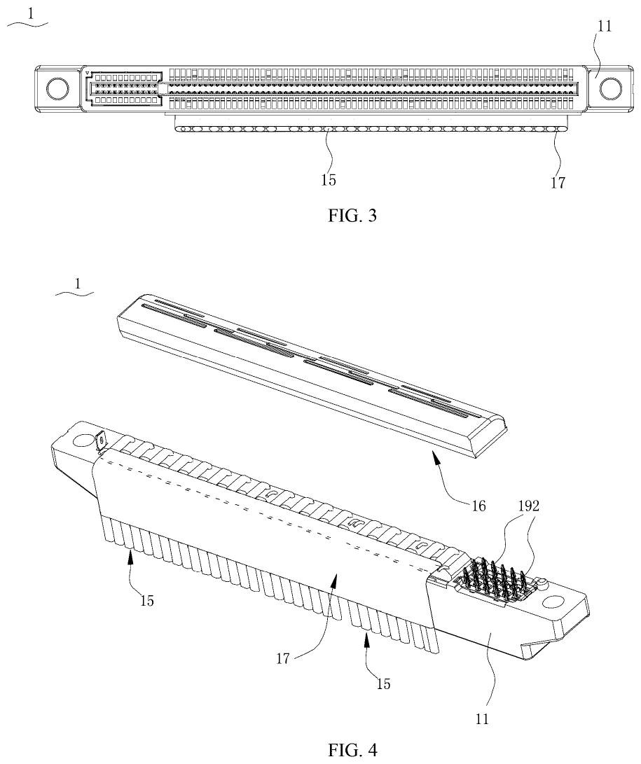

Referring to FIG. 1 to FIG. 8, an electrical connector 1 of a preferred embodiment includes a first insulative housing 11, a plurality of first conductive terminals 12, a plurality of wires 151, a protect housing 16 and a ribbon sealing member 17. The ribbon sealing member 17 seals gaps between respective adjacent wires 151, in turn can prevent a molten plastic material from seeping through the gaps between the respective adjacent wires 151 when the protect housing 16 is injection molded, so that a molding die can easily accommodate different changes of an arrangement of the wires 151, design requirement on the molding die is lowered and development cost of the molding die is lowered, cost and time required due to change in a molding die when a wiring manner changes are also reduced.

For sake of convenient description, when an orientation is described hereinafter, in the electrical connector 1, an inserting end of the electrical connector 1 is defined as front, a direction away from the inserting end is defined as rear, a direction perpendicular to front and rear is defined as left and right.

Continuously referring to FIG. 6 to FIG. 8, the first insulative housing 11 substantially is a rectangular strip structure which extends along a left-right direction. The first insulative housing 11 is an insulative material, and preferably is a structure integrally injection molded with a plastic material.

A front end of the first insulative housing 11 is provided with a first mating cavity 111.

The plurality of first conductive terminals 12 are arranged in the first mating cavity 111. In the present embodiment, the plurality of first conductive terminals 12 are arranged into an upper row and a lower row, and are respectively provided at an upper side and a lower side of the first mating cavity 111. In other embodiments, the plurality of first conductive terminals 12 also may be arranged as a single row, or may be arranged as more than two rows.

The first conductive terminals 12 in each row are arranged along a left-right direction. The plurality of first conductive terminals 12 includes multiple groups of differential signal pair terminals, each group of differential signal pair terminals correspondingly connects one cable 15.

Referring to FIG. 16, each group of differential signal pair terminals includes two signal terminals 121 which are provided in pair and two ground terminals 122 which are respectively positioned to two sides of the two signal terminals 121. That is, the two signal terminals 121 and the two ground terminals 122 constitute one group of differential signal pair terminals.

Each first conductive terminal 12 includes an elastic mating portion 1222 which is exposed out from the first insulative housing 11, a soldering portion 1221 which is connected with one wire 151 and a fixing portion 1223 which is positioned in the first insulative housing 11, the fixing portion 1223 is connected between the elastic mating portion 1222 and the soldering portion 1221. That is, the elastic mating portion 1222 is positioned to a front end of the first conductive terminal 12, the soldering portion 1221 is positioned to a rear end of the first conductive terminal 12. Where, a structure of the signal terminal 121 and a structure of the ground terminal 122 are similar, the signal terminal 121 is used to transmit a high-speed signal, and the ground terminal 122 is used to provide electromagnetic shielding for the signal terminal 121.

The soldering portion 1221 of the first conductive terminal 12 preferably is subjected to a thinning process so that a thickness of the soldering portion 1221 is smaller than a thickness of the other portion of the first conductive terminal 12, thereby promoting an impedance of the first conductive terminal 12, being beneficial to promote signal integrity (SI) when the electrical connector 1 transmits a high-speed signal. Here, taking a use state of the electrical connector 1 as reference, the thickness refers to a dimension along an up-down direction.

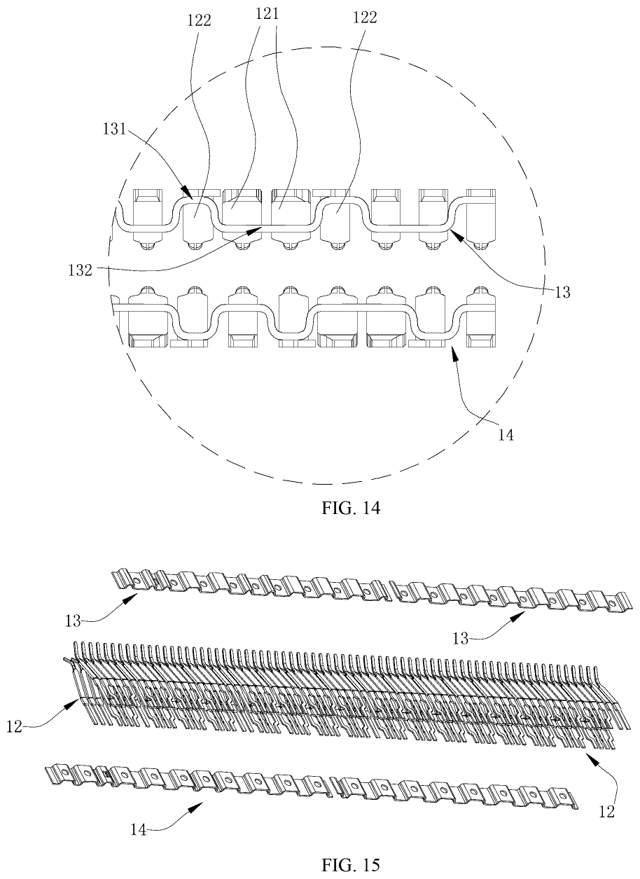

As shown in FIG. 14, the electrical connector 1 further includes at least one first shielding plate 13. The first shielding plate 13 is provided between the upper row of first conductive terminals 12 and the lower row of first conductive terminals 12, the corresponding ground terminals 122 of the first conductive terminals 12 are electrically connected with the first shielding plate 13. The first shielding plate 13 may lower signal crosstalk between the upper row of first conductive terminals 12 and the lower row of first conductive terminals 12, promote quality of signals to be transmitted. The soldering portion 1221 of the ground terminal 122 in the upper row also preferably is thinned upwardly, so that the soldering portions 1221 of the ground terminals 122 in the upper row may be soldered above the first shielding plate 13 and are maintained in the same plane with upper surfaces of the signal terminals 121.

The first shielding plate 13 is in form of wave-shape and extends along an arrangement direction of the first conductive terminals 12, that is, the first shielding plate 13 extends along the left-right direction. Referring to FIG. 17, the first shielding plate 13 includes multiple peak portions 131 and multiple valley portions 132 which are alternately arranged. Where, the peak portion 131 refers to a part which bulges upwardly along the up-down direction, conversely the valley portion 132 refers to a part which bulges downwardly along the up-down direction.

The signal terminals 121 do not contact the first shielding plate 13, and the signal terminals 121 of the same differential signal pair terminal are correspondingly positioned at the valley portion 132, and the signal terminals 121 of the same differential signal pair terminal and the valley portion 132 form a spacing therebetween. Specifically, the signal terminals 121 and the valley portion 132 have a spacing therebetween along the up-down direction, the signal terminals 121 and the peak portions 131 have spacing therebetween along the left-right direction, so that the signal terminals 121 does not electrically contact the first shielding plate 13.

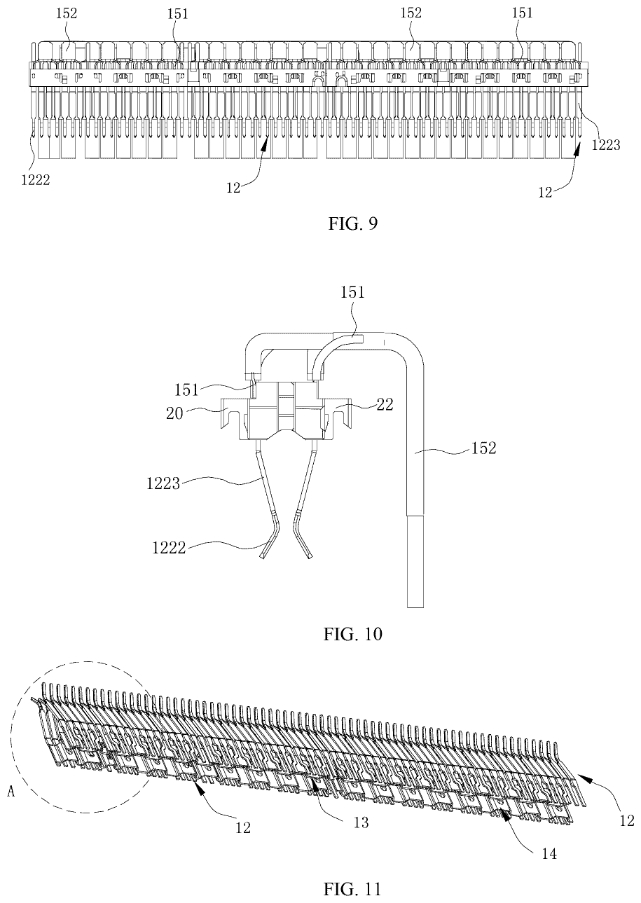

Referring to FIG. 9 and FIG. 10, specifically, in the preferred embodiment, multiple differential signal cables 15 and the multiple groups of differential signal pair terminals are provided as one-to one correspondence. Each differential signal cable 15 includes multiple wires 151 and a cable jacket 152 which encloses an outer peripheral of the multiple wires 151. Where, each differential signal cable 15 includes two signal wires 151 and two ground wires 151. These wire 151 are correspondingly connected to the rear end of the first conductive terminal 12. It is noted that, the present disclosure, the wires may be embodied as various forms, specifically, in the preferred embodiment, the wires 151 are provided in the differential signal cable 15, in some embodiments not shown, these wire also may a differential signal cable, multiple independent single core wires, a flat wiring or a combination thereof.

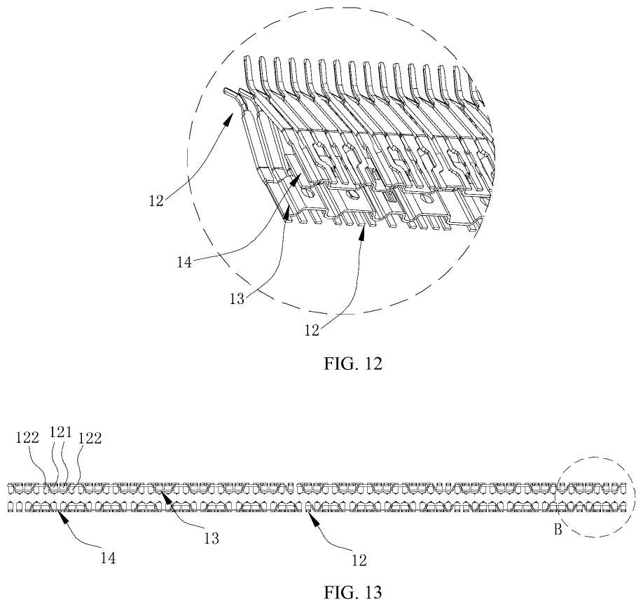

Referring to FIG. 11 to FIG. 14, positions of the two signal terminals 121 of the same differential signal pair terminal projected in the up-down direction are correspondingly positioned in the valley portion 132. The ground terminal 122 of the same differential signal pair terminal contacts the peak portion 131 and electrically connects with the peak portion 131. Where, the ground terminal 122 is soldered to the peak portion 131. Specifically, the two ground terminals 122 is electrically connected with the two peak portions 131, which are respectively adjacent to the corresponding valley portion 132 of the signal terminal 121, by one-to one correspondence.

The soldering portion 1221 of the ground terminal 122 engages with the peak portion 131 preferably by a laser welding. By the laser welding, welding quality is promoted, in turn a structure strength of the electrical connector 1 is promoted. In addition, a welding precision of the laser welding is higher, accuracy and reliability of the connected points are promoted, so that the SI performance of the electrical connector 1 is promoted.

The elastic mating portion 1222 preferably contacts a gold finger on an upper side and a lower side of another mating circuit board (not shown), so as to establish communication.

Specifically, the first mating cavity 111 includes a mating slot 1111 and a plurality of terminal cavities 1112 which are respectively positioned to an upper side and a lower side of the mating slot 1111. The mating slot 1111 extends along the left-right direction. The terminal cavities 1112 which are positioned to the upper side of the mating slot 1111 are arranged side by side along the left-right direction, the terminal cavities 1112 which are positioned to the lower side of the mating slot 1111 also are arranged side by side along the left-right direction. The plurality of terminal cavities 1112 are communicated with the mating slot 1111. The upper row of the first conductive terminals 12 and the lower row of the first conductive terminals 12 are arranged with respect to the mating slot 1111 in a mirror symmetry manner. The soldering portion 1221 of the first conductive terminal 12 rearwardly extends out of a rear end of the first insulative housing 11. The elastic mating portion 1222 of the first conductive terminal 12 is in form structure whose a middle portion bends toward an interior of the terminal cavity 1112, two ends of the elastic mating portion 1222 are positioned in the terminal cavity 1112, a middle portion of the elastic mating portion 1222 is positioned in the mating slot 1111.

Continuously referring to FIG. 16, one differential signal pair terminal of the first conductive terminal 12 is illustrated, where, the soldering portion 1221 of the two ground terminals 122 which are positioned to the two sides of the two signal terminals 121 includes a soldering portion front section 1227 which is connected with the fixing portion 1223 and a soldering portion rear section 1226 which is bent from the soldering portion front section 1227 and is used to be connected with the corresponding wire 151. In the same group of differential signal pair terminal, a pitch between the soldering portion rear sections 1226 of the two ground terminals 122 is smaller than a pitch between the two soldering portion front sections 1227 of the two ground terminals 122.

Specifically, the soldering portion front section 1227 and the soldering portion rear section 1226 are connected therebetween by a transitioning portion which extends obliquely. The transitioning portion is oblique from front to rear toward an interior of the differential signal pair terminal, so that the pitch between the two soldering portion rear sections 1226 is smaller than the pitch between the two soldering portion front sections 1227.

After the pitch between the two soldering portion rear sections 1226 of the two ground terminals 122 is reduced, impedance is lowered, it is more beneficial for the two ground terminals 122 to provide ground shielding for the two signal terminals 121. And, after the pitch between the two soldering portion rear sections 1226 of the two ground terminals 122 is reduced, a distance between the two corresponding ground wires 151 which are respectively connected with the two soldering portion rear sections 1226 is reduced, which facilitates soldering of the two corresponding ground wires 151 respectively with the two soldering portion rear sections 1226.

A width of the fixing portion 1223 of the first conductive terminal 12 is larger than a width of the other portion of the first conductive terminal 12. That is, the width of the fixing portion 1223 is larger than a width of the elastic mating portion 1222, the width of the fixing portion 1223 also is larger than a width of the soldering portion 1221. Where, the width refers to a dimension along the left-right direction.

A design that the width of the fixing portion 1223 is maximum not only ensures an entire strength of the first conductive terminal 12, but also makes that the fixing portion 1223 can snap in the first mating cavity 111 of the first insulative housing 11, connecting stability between the first conductive terminal 12 and the first insulative housing 11 is ensured.

Specifically, a left side and a right side of the fixing portion 1223 are beyond the elastic mating portion 1222. An outer side wall of the fixing portion 1223 is flush with an outer side wall of the soldering portion front section 1227, an inner side wall of the fixing portion 1223 of the ground terminal 122 is beyond an inner side wall of the soldering portion front section 1227 toward the interior of the differential signal pair terminal.

Referring to FIG. 14, in the preferred embodiment, the electrical connector 1 further includes a second shielding plate 14. The second shielding plate 14 further lowers signal crosstalk between the upper row of first conductive terminals 12 and the lower row of first conductive terminals 12, promotes quality of the signals to be transmitted, at the same time, further lowers signal crosstalk between the signal terminals 121 in the lower row of first conductive terminals 12.

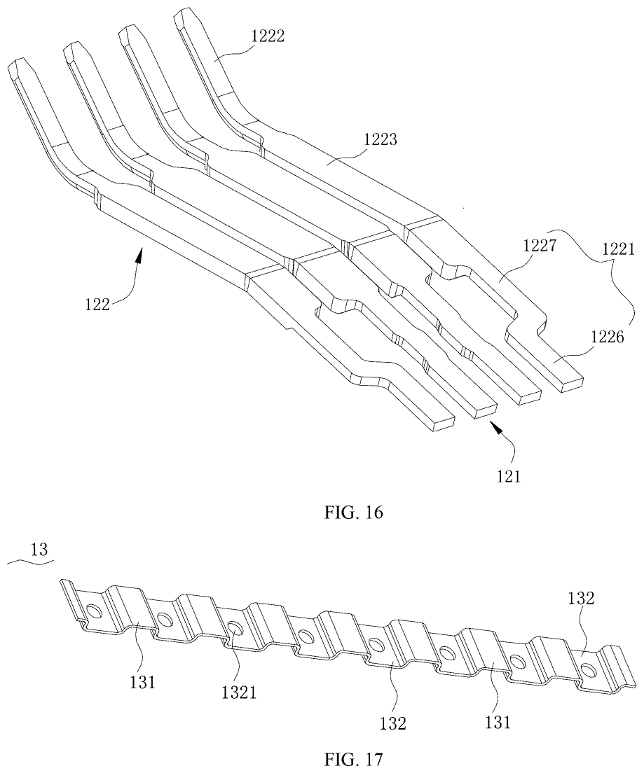

Referring to FIG. 11 to FIG. 15, the second shielding plate 14 is provided between the lower row of first conductive terminals 12 and the first shielding plate 13, and has a spacing with the first shielding plate 13. A structure of the second shielding plate 14 is substantially the same as a structure of the first shielding plate 13. That is, the second shielding plate 14 is in form of wave-shape and extends along the left-right direction, the second shielding plate 14 includes multiple peak portions and multiple valley portions which are alternately arranged up and down. The ground terminals 122 of the first conductive terminals 12 positioned below are connected with the valley portions of the second shielding plate 14, the signal terminal 121 does not contact the peak portion of the second shielding plate 14. Preferably, the signal terminals 121 in the upper row of first conductive terminals 12 and the signal terminals 121 in the lower row of first conductive terminals 12 are provided to be stagger with each other. Together with referring to FIG. 10, a rear portion of the upper row of first conductive terminals 12 and the first shielding plate 13 are fixed on a first terminal module 20, and a rear portion of the lower row of first conductive terminals 12 and the second shielding plate 14 are fixed on a second terminal module 22, and the first terminal module 20 and the second terminal module 22 face each other and are fixed together. The valley portion 132 is preferably provided thereon with a through hole 1321, the through hole 1321 is positioned above or below projections of the two signal terminals 121, the through holes 1321 provided on the first shielding plate 13 are used to allow that a molten plastic material may easily passes through the first shielding plate 13 when the first terminal module 20 is molded, which is beneficial for the first terminal module 20 to be smoothly molded.

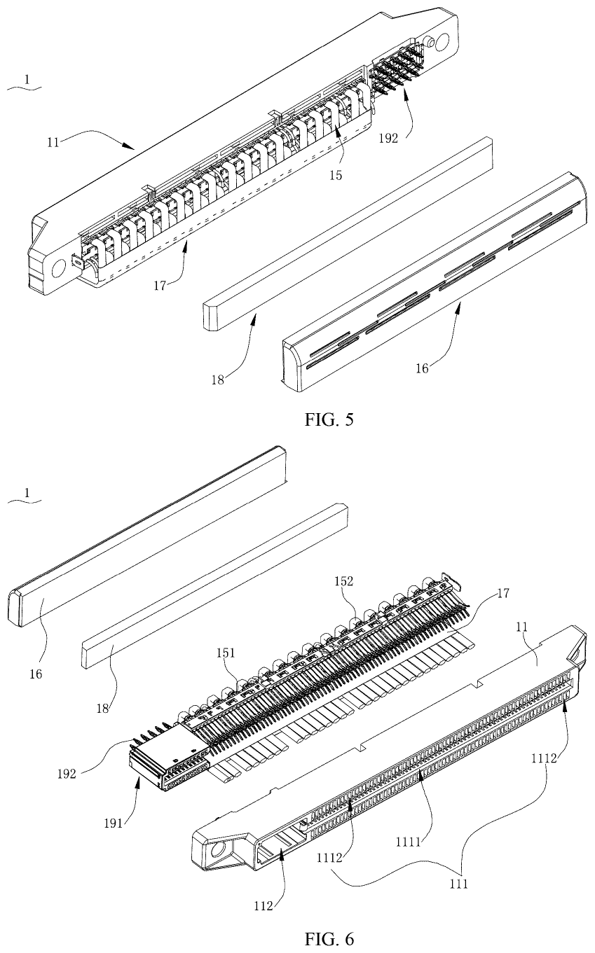

Continuously referring to FIG. 5 to FIG. 7, outer peripherals of connected positions between the soldering portions 1221 of the first conductive terminals 12 and the wires 151 are covered with a protecting adhesive layer 18, to protect soldered points and to be beneficial to reduce impedance change caused when the protect housing 16 is subsequently molded. Here, the protecting adhesive layer 18 may be a ultraviolet ray curable adhesive layer (UV adhesive layer).

The protect housing 16 is provided to a rear end of the first insulative housing 11. After the plurality of wires 151 and the plurality of first conductive terminals 12 are soldered and then are covered by the protecting adhesive layer 18, the protect housing 16 may be integrally injection molded on the rear end of the first insulative housing 11, the protect housing 16 prevents an external pulling force from being transferred to the first conductive terminal 12 by the wire 151, ensures reliability of electrical connection between the plurality of wires 151 and the plurality of first conductive terminals 12, so that stability of the signals to be transmitted by the electrical connector 1 is promoted.

Referring to FIG. 1, the protect housing 16 is formed by injection molding and partially covers an outer peripheral of the ribbon sealing member 17. Preferably, the protect housing 16 is integrally molded on the rear end of the first insulative housing 11, so that the protect housing 16 covers a portion of the ribbon sealing member 17 close to the first conductive terminals 12 therein.

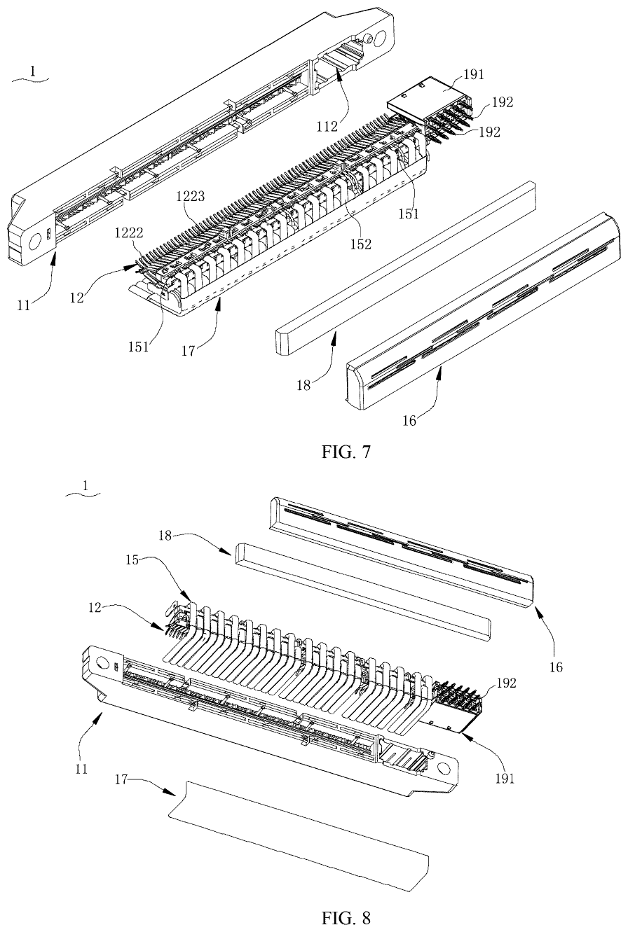

Referring to FIG. 7 and FIG. 8, the ribbon sealing member 17 wraps on an outer peripheral of the plurality of wires 151, to seal the gaps between respective adjacent wires 151. Where, one portion of the ribbon sealing member 17 close to the first conductive terminals 12 are embedded in the protect housing 16, the other portion of the ribbon sealing member 17 outwardly extends out of the protect housing 16 to be exposed out from the protect housing 16.

Specifically, the ribbon sealing member 17 preferably has adhesive, and is adhered with the plurality of wires 151 together. The ribbon sealing member 17 is adhered with the plurality of wires 151 at the same time to realize connection. In the present embodiment, the ribbon sealing member 17 preferably is an insulative adhesive tape (such as acetic acid adhesive fabric).

The ribbon sealing member 17 at least needs to wrap the plurality of wires 151 by a circle, also may wrap the plurality of wires 151 by circles, which specifically may be provided depend on practical need.

Manufacturing and assembling steps of the electrical connector 1 are as follows: the first terminal module 20 and the second terminal module 22 are inserted into the first insulative housing 11, then a plurality of wires 151 are correspondingly connected to the rear ends of the first conductive terminals 12. Here, the wire 151 and the corresponding first conductive terminal 12 preferably realize electrical connection therebetween by a solder. Next, connected positions of the wires 151 and the first conductive terminals 12 are coated with the protecting adhesive layer 18, then the ribbon sealing member 17 wraps and covers the outer peripheral of the wires 151 at appropriate positions of the wires 151. Finally a molding die presses against the ribbon sealing member 17, so that a portion of the ribbon sealing member 17 is in the molding die and the other portion of the ribbon sealing member 17 is exposed out from the molding die, a molten plastic material is injected into the molding die and then is cooled and molded to obtain the protect housing 16.

Because the ribbon sealing member 17 seals the gaps between respective adjacent wires 151, the ribbon sealing member 17 can prevent the molten plastic material from seeping through the gaps between the respective adjacent wires 151 when the protect housing 16 is injection molded. Provision of the ribbon sealing member 17 makes the molding die which is used to mold the protect housing 16 in the electrical connector 1 need not to be provided with recessed grooves corresponding to the wires 151, therefore, a structure of the molding die is simplified and cost of the molding die is lowered, it further may make that the molding die can easily accommodate different changes of an arrangement of the wires 151, so that cost and time required due to change in a molding die is reduced.

Continuously referring to FIG. 6 to FIG. 8, the first insulative housing 11 is further provided with a receiving cavity 112 at a side of the first mating cavity 111. The receiving cavity 112 penetrates front and rear. The electrical connector 1 further includes a second insulative housing 191 and a plurality of second conductive terminals 192. The second insulative housing 191 substantially is in form of rectangular block, and matches with the receiving cavity 112 of the first insulative housing 11, so that the second insulative housing 191 can be inserted into the receiving cavity 112. A front end of the second insulative housing 191 is provided with a second mating cavity, the plurality of second conductive terminals 192 are arranged in the second mating cavity.

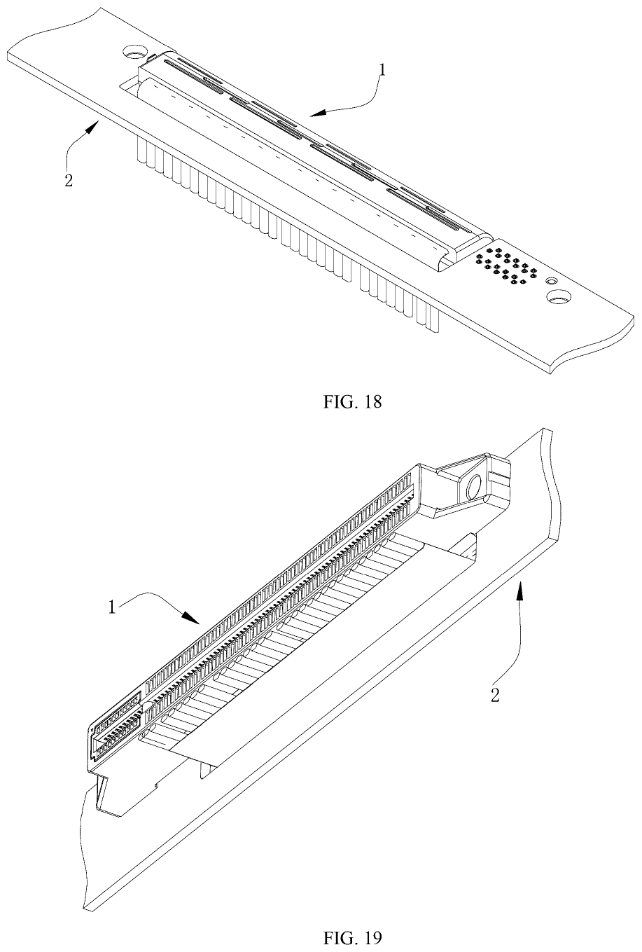

Referring to FIG. 18 and FIG. 19, the electrical connector 1 may be fixed on a circuit board 2 to constitute an electrical connector assembly. The circuit board 2 provides an adapting function for the electrical connector 1, at the same time the circuit board 2 may be further provided with electronic elements, such as a chip and the like, and form an electrical connection via the second conductive terminals 192 of the electrical connector 1.

Although the present disclosure has been described with reference to several typical embodiments, it should be understood that the terminology used is illustrative and exemplary rather than limiting. Since the present disclosure can be embodied in various forms without departing from the spirit or essence of the present disclosure, it should be understood that the above embodiments are not limited to any of the foregoing details, but should be widely interpreted within the spirit and scope defined by the appended claims, therefore, all variations and modifications falling within the scope of the claims or equivalent ranges of the claims should be covered by the appended claims.

What is claimed is:

1. An electrical connector, comprising:
a first insulative housing, a front end of the first insulative housing being provided with a first mating cavity;
a plurality of first conductive terminals which are arranged in the first mating cavity;
a plurality of wires which are correspondingly connected to rear ends of the plurality of first conductive terminals;
a protect housing which is provided to a rear end of the first insulative housing;
a ribbon sealing member which is wrapped on an outer peripheral of the plurality of wires to seal gaps between respective adjacent wires;
wherein the protect housing is formed by injection molding and partially covers on an outer peripheral of the ribbon sealing member, one portion of the ribbon sealing member is embedded in the protect housing, the other portion of the ribbon sealing member extends outwardly to be exposed out from the protect housing.

2. The electrical connector of claim 1, wherein the ribbon sealing member has adhesive, and is adhered with the plurality of wires together.

3. The electrical connector of claim 2, wherein
the ribbon sealing member is an insulative adhesive tape,
the protect housing is integrally molded on the rear end of the first insulative housing so that the protect housing covers a portion of the ribbon sealing member close to the plurality of first conductive terminals therein.

4. The electrical connector of claim 1, wherein
the plurality of first conductive terminals are arranged into an upper row and a lower row,
the electrical connector further comprises at least one first shielding plate which is provided between the upper row of first conductive terminals and the lower row of first conductive terminals,
the first shielding plate is in form of wave-shape and extends along an arrangement direction of the first conductive terminals, the first shielding plate comprises multiple peak portions and multiple valley portions which are alternately arranged, the valley portion is provided thereon with a through hole, ground terminals of the first conductive terminals are welded to the peak portions.

5. The electrical connector of claim 4, wherein
the plurality of first conductive terminals comprises multiple groups of differential signal pair terminals,
each group of differential signal pair terminal comprises two signal terminals which are provided in pair and the two ground terminals which are respectively positioned to two sides of the two signal terminals, the two signal terminals does not contact the first shielding plate, and the two signal terminals and the valley portion form a spacing therebetween.

6. The electrical connector of claim 5, wherein
each first conductive terminal comprises an elastic mating portion, a soldering portion which is connected with the wire and a fixing portion which is connected between the elastic mating portion and the soldering portion,
wherein in the same group of differential signal pair terminal, the two soldering portions of the two ground terminals extend close to each other relative to the two elastic mating portions of the two ground terminals.

7. The electrical connector of claim 6, wherein
the soldering portion of the ground terminal comprises a soldering portion front section which is connected with the fixing portion and a soldering portion rear section which is bent from the soldering portion front section and is used to be connected with the wire,
wherein in the same group of differential signal pair terminal, a pitch between the two soldering portion rear sections of the two ground terminals is smaller than a pitch between the two soldering portion front sections of the two ground terminals.

8. The electrical connector of claim 6, wherein
a thickness of the soldering portion of the first conductive terminal is smaller than a thickness of the other portion of the first conductive terminal.

9. The electrical connector of claim 6, wherein
outer peripherals of connected positions between the soldering portions of the first conductive terminals and the wires are covered with a protecting adhesive layer.

10. The electrical connector of claim 1, wherein
the first insulative housing is provided with a receiving cavity at a side of the first mating cavity,
the electrical connector further comprises a second insulative housing and a plurality of second conductive terminals,
the second insulative housing is inserted into the receiving cavity, a front end of the second insulative housing is provided with a second mating cavity,
the plurality of the second conductive terminals are arranged in the second mating cavity.
